(19) United States
(12) Patent Application Publication
(10) Pub. No.: US 2007/0024393 A1
(43) Pub. Date: Feb. 1, 2007

(54) Tunable notch duplexer

(76) Inventors: Roger J. Forse, Santa Barbara, CA (US); Glenn A. Sanderson, Carpinteria, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/492,344

(22) Filed: Jul. 24, 2006

Related U.S. Application Data
(60) Provisional application No. 60/703,296, filed on Jul. 27, 2005.

(51) Int. Cl. H01P 1/213

(52) U.S. Cl. 333/134

(57) ABSTRACT

A duplexer for bidirectional communication systems includes tunable band reject filters. The tunable band reject filter on the receiver side can be tuned to reject the transmit signal frequency, and the tunable band reject filter on the transmitter side can be tuned to reject the receive signal frequency. Thus, the band reject filters allow for simultaneous tuning of the band reject frequencies on the transmission side and the reception side. The tunable band reject filters can be implemented as resonators including barium strontium titanate (BST) capacitors of which the capacitance can be tuned according to bias voltages applied to the BST capacitors.

### CROSS-REFERENCE TO RELATED APPLICATION

This application claims priority under 35 U.S.C. §119(e) from co-pending U.S. Provisional Patent Application No. 60/703,296, entitled “Tunable Notch Duplexer,” filed on Jul. 27, 2005, which is incorporated by reference herein in its entirety.

### BACKGROUND OF THE INVENTION

1. Field of the Invention

The present invention generally relates to the field of duplexers, and more specifically, to a duplexer for simultaneous transmission and reception of wireless communication signals utilizing band reject filters comprised of thin film barium strontium titanate (BST) capacitors.

2. Description of the Related Art

Duplexers are widely used in telecommunications circuits where transmit and receive functions are at different frequencies. Their primary function is to allow the simultaneous transmitting and receiving of signals, which is traditionally done with two band pass filters. As illustrated in FIG. 1, one band pass filter 108 covers the transmit band and the other band pass filter 106 covers the receive band. However, these filters 108, 106 are difficult to implement if the frequency range between the two filters is narrow compared to their bandwidths.

Presently, duplexers based on band pass filters are built using coaxial resonators, surface-acoustic-wave (SAW) resonators, and bulk-acoustic-wave (BAW) resonators. Each of these implementations sacrifices performance on the edge of the bands to help make the components small and low cost. Further, components that vary with temperature (e.g., SAW and BAW resonators) also cause compromises in performance or extra guard-banding.

Hence, there is a need for a duplexer that provides improved performance on the edges of a band without a significant increase in cost, while also providing easier realization in tighter frequency ranges between filters.

### SUMMARY OF THE INVENTION

Embodiments of the present invention include a duplexer that includes a tunable notch band reject filter. The duplexer allows for simultaneous tuning of the transmission and reception notch. In addition, one example of a tuning element includes a resonator comprised of a barium strontium titanate (BST) tuning element.

In one embodiment, a duplexer is configured for use in a wireless communication system. The duplexer is coupled to a transmitter configured to transmit a transmit signal at a first frequency in a first frequency range and to a receiver configured to receive a receive signal at a second frequency in a second frequency range. The duplexer comprises a first tunable band reject filter coupled to the receiver and tunable to reject the first frequency of a transmit signal in the first frequency range, and a second tunable band reject filter coupled to the transmitter and tunable to reject the second frequency of a receive signal in the second frequency range. The first tunable band reject filter comprises a first resonator including at least a first barium strontium titanate (BST) capacitor of which the capacitance is tunable by a first bias voltage applied to the first BST capacitor, and the second tunable band reject filter comprises a second resonator including at least a second barium strontium titanate (BST) capacitor of which the capacitance is tunable by a second bias voltage applied to the second BST capacitor.

The tunable notch duplexer of the present invention has the advantage of having a single filter on each side of a communication frequency band range rather than a separate filter for each channel within each band. Thus, this configuration reduces manufacturing costs and allows for a reduction in size due to reduction in components.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 illustrates a conventional band pass filter based duplexer.

FIG. 2A illustrates a band reject filter (BRF) based tunable notch duplexer with a tunable BST capacitor, according to one embodiment of the present invention.

FIG. 2B illustrates the frequency characteristics of the tunable notch duplexer of FIG. 2A, according to one embodiment of the present invention.

FIG. 2C illustrates the circuitry of the tunable notch duplexer of FIG. 2A, according to one embodiment of the present invention.

FIG. 3A illustrates the insertion loss versus frequency characteristics of the tunable notch duplexer of FIG. 2A tuned to a low frequency band, according to one embodiment of the present invention.

FIG. 3B illustrates the insertion loss versus frequency characteristics of the tunable notch duplexer of FIG. 2A tuned to a mid-frequency band, according to one embodiment of the present invention.

FIG. 3C illustrates the insertion loss versus frequency characteristics of the tunable notch duplexer of FIG. 2A tuned to a high frequency band, according to one embodiment of the present invention.

### DETAILED DESCRIPTION OF EMBODIMENTS

The Figures (FIGS. ) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

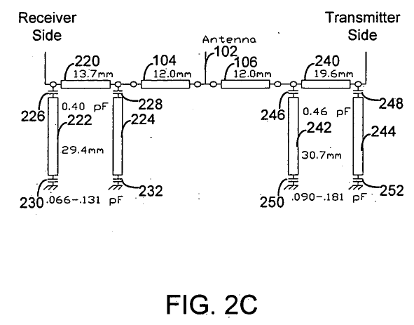

The embodiments disclosed herein offer design flexibility that provides application advantages to devices such as mobile handsets. For example, FIG. 2A illustrates one embodiment of a tunable notch duplexer used in a cellular telephone handset application where only one transmit frequency and one receive frequency are used at any one time. Although the tunable notch duplexer of FIG. 2A is explained in the context of use with a cellular telephone handset, it should be noted that the tunable notch duplexer of the present invention can be used in any other type of application. The duplexer includes phase delay lines 104, 106 and tunable notch band reject filters (BRF) 202, 204. The phase delay lines 104, 106 present an open circuit so as to keep the BRFs 202, 204 from loading the transmit and receive ports.

On the receiver side, a signal is received via the antenna 102 and passed through the phase delay line 104 and the tunable band reject filter (BRF) 202 to a baseband processor (not shown) of a mobile handset. On the transmitter side, the transmit signal from a power amplifier (not shown) is passed through the tunable band reject filter (BRF) 204 and a phase delay line 106 and is transmitted via the antenna 102. The tunable BRF 202 associated with the receiver is configured to reject the transmit signal's frequency so that the transmit signal is not partially lost to the receiver side. The tunable BRF 202 can be tuned to reject any frequency in the transmit frequency band of 1850-1910 MHz, which is the frequency range of the transmit signal. Likewise, the tunable BRF 204 associated with the transmitter side is configured to reject the receive signal's frequency so that the receive signal is not partially lost to the transmitter side. The tunable BRF 204 can be tuned to reject any frequency in the receive frequency band of 1930-1990 MHz, which is the frequency range of the receive signal.

FIG. 2B illustrates the frequency characteristics of the tunable notch duplexer of FIG. 2A, according to one embodiment of the present invention. In this example, rather than having a notch filter at each frequency in the transmit frequency band 202′ and the receive frequency band 204′, a tunable notch BRF can be configured to operate in each band. More specifically, FIG. 2B shows that the tunable BRF 202 on the receiver side is tuned to reject a transmit signal frequency of 1860 MHz in the transmit frequency band 202′ of 1850-1910 MHz and that the tunable BRF 204 on the transmitter side is tuned to reject a receive signal frequency of 1940 MHz in the receive frequency band 204′ of 1930-1990 MHz. If the transmit signal frequency and/or the receive signal frequency changes within their respective frequency bands 202′, 204′, the tunable BRFs 202, 204 are also tuned to reject the changed transmit or receive signal frequencies.

FIG. 2C illustrates the circuitry of the tunable notch duplexer of FIG. 2A, according to one embodiment of the present invention. Referring to FIG. 2C, the phase delay lines 104, 106 are implemented as transmission lines with lengths of 12.0 mm.

The tunable BRF 202 on the Receiver (Rcv) side is comprised of the transmission line 220 (13.7 mm), transmission line 222 (29.4 mm), transmission line 224 (29.4 mm), fixed capacitors 226, 228 (both 0.40 pF), and tunable capacitors 230, 232 (both tunable within a range of 0.066-0.131 pF), which together form a resonator. The tunable capacitors 230, 232 are tunable barium strontium titanate (BST) capacitors (or BST varactors) of which the capacitance can be tuned by controlling the DC bias voltage applied to the BST capacitors 230, 232. The tunable BST capacitors 230, 232 are tuned together. The BRF 202 rejects 1850 MHz when the BST capacitors 230, 232 are tuned to 0.131 pF. The BRF 202 rejects 1910 MHz when the BST capacitors 230, 232 are turned to 0.066 pF. If the BST capacitors 230, 232 are tuned to a capacitance value between 0.066 pF and 0.131 pF, the BRF 202 will reject a frequency between 1850 MHz and 1910 MHz.

The tunable BRF 204 on the Transmitter (Xmt) side is comprised of the transmission line 240 (19.6 mm), transmission line 242 (30.7 mm), transmission line 244 (30.7 mm), fixed capacitors 246, 248 (both 0.46 pF), and tunable capacitors 250, 252 (both tunable within a range of 0.090-0.181 pF), which together form a resonator. The tunable capacitors 250, 252 are tunable barium strontium titanate (BST) capacitors (or BST varactors) of which the capacitance can be tuned by controlling the DC bias voltage applied to the BST capacitors 250, 252. The tunable BST capacitors 250, 252 are turned together. The BRF 204 rejects 1930 MHz when the BST capacitors 250, 252 are tuned to 0.181 pF. The BRF 204 rejects 1990 MHz when the BST capacitors 250, 252 are turned to 0.090 pF. If the BST capacitors 250, 252 are tuned to a capacitance value between 0.090 and 0.181 pF, the BRF 204 will reject a frequency between 1930 MHz and 1990 MHz.

Note that the transmission lines 104, 106, 220, 240, 222, 224, 242, 244 can be fabricated on any structure suitable for transmission lines, including co-axial resonators, ceramic, surface-acoustic-wave (SAW), bulk-acoustic-wave, and printed circuit board.

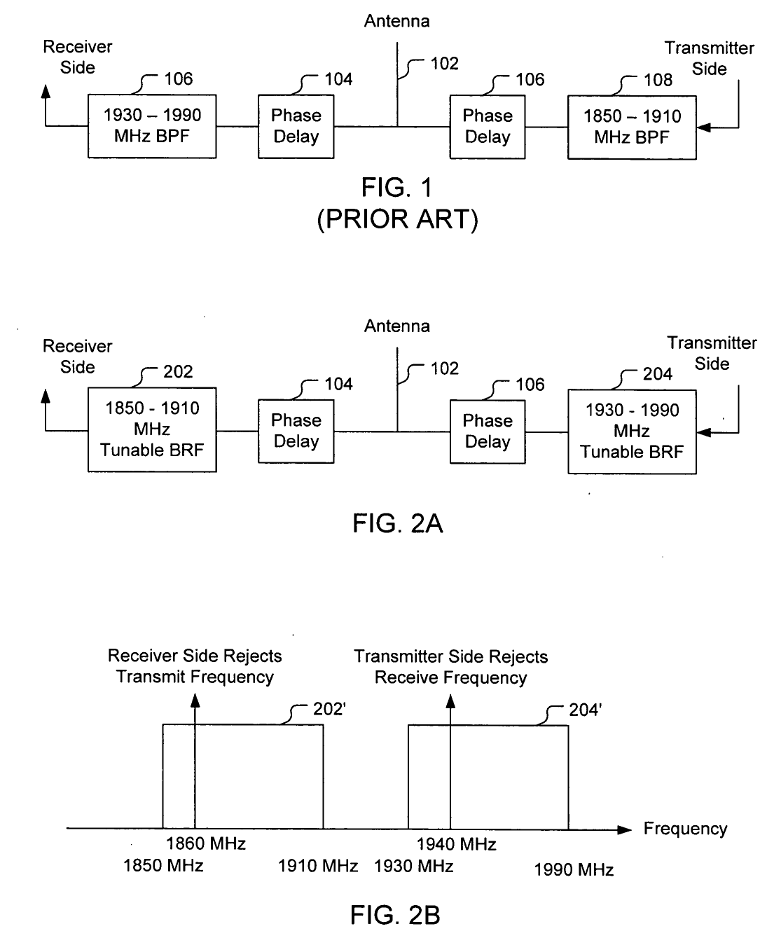

The tunable duplexer shown in FIGS. 2A-2C has the advantage that the BRFs 202, 204 have minimum loss for the frequency that the handset is tuned to. The tunable BST capacitors 230, 232, 250, 252 allow the duplexer to be tuned to the correct frequency without having to design sharp filters to cover all frequencies simultaneously, since a wireless communication handset typically only uses one transmit or receive frequency at any given moment. The tunable notch duplexer in FIGS. 2A-2C offers the same isolation as the band-pass configuration in FIG. 1. At the same time, the tunable notch duplexer of FIG. 2A-2C beneficially provides less insertion loss and little compromise (or losses) at the band edges compared to the band-pass configuration of FIG. 1. In addition, the notch filter can be configured so that the band reject frequency is tunable across the entire band depending on the communication channel in use.

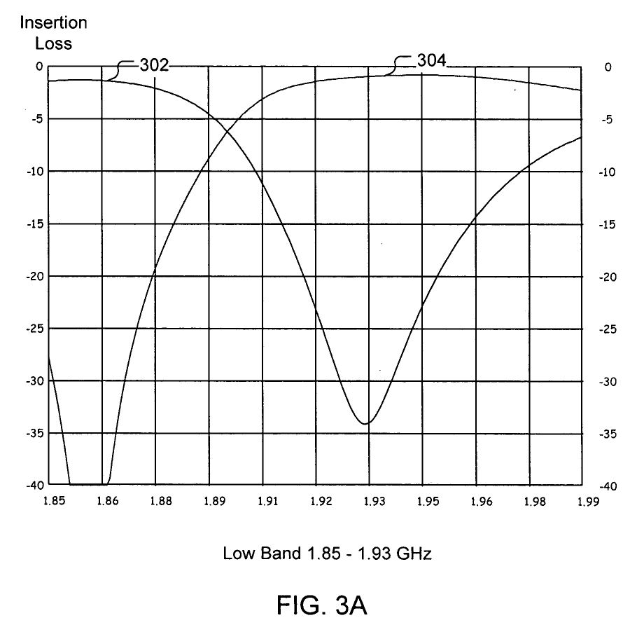

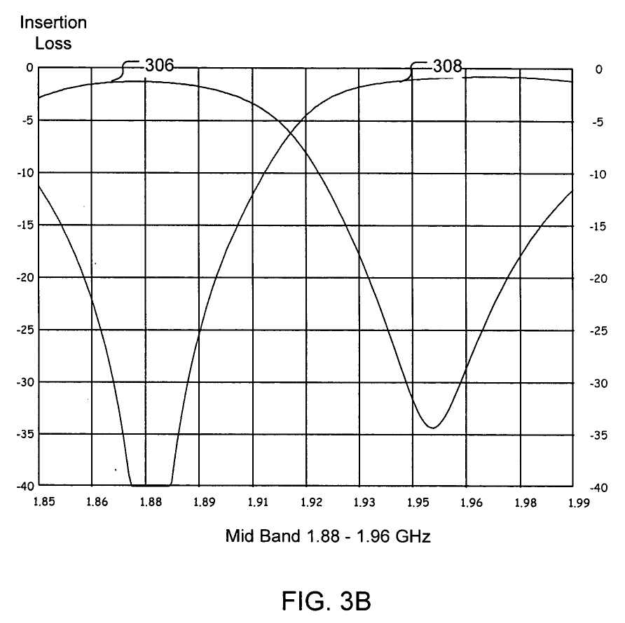

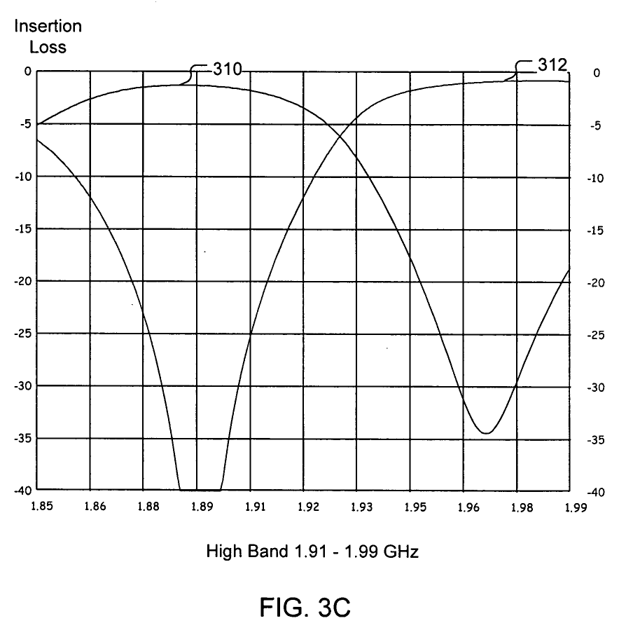

FIG. 3A illustrates the insertion loss versus frequency characteristics of the tunable notch duplexer of FIG. 2A tuned to a low frequency band (1.85-1.93 GHz), according to one embodiment of the present invention. In the example of FIG. 3A, the BST capacitors 230, 232 were turned to 0.131 pF and the BST capacitors 250, 252 were turned to 0.181 pF. The line 302 corresponds to the insertion loss characteristics on the transmitter side, and the line 304 corresponds to the insertion loss characteristics on the receiver side. As shown in line 302, the transmitter side shows minimal (approximately 1 dB) insertion loss for the transmit signal frequency around 1.86 GHz and maximum (approximately 32 dB) rejection of the receive signal frequency around 1.94 GHz. As shown in line 304, the receiver side shows minimal (approximately 1 dB) insertion loss for the receive signal frequency around 1.94 GHz and maximum (approximately 40 dB or more) rejection of the transmit signal frequency around 1.86 GHz.

FIG. 3B illustrates the insertion loss versus frequency characteristics of the tunable notch duplexer of FIG. 2A tuned to a mid-frequency band (1.88-1.96 GHz), according to one embodiment of the present invention. In the example of FIG. 3B, the BST capacitors 230, 232 were turned to approximately 0.099 pF and the BST capacitors 250, 252 were turned to 0.135 pF. The line 306 corresponds to the insertion loss characteristics on the transmitter side, and the line 308 corresponds to the insertion loss characteristics on the receiver side. Lines 306 and 308 are similar in shape to the lines 302 and 304 of FIG. 3A, respectively, except that the lines 306 and 308 are shifted to a higher frequency due to the lower values of the capacitances to which the BST capacitors 230, 232, 250, 252 are tuned.

FIG. 3C illustrates the insertion loss versus frequency characteristics of the tunable notch duplexer of FIG. 2A tuned to a high frequency band (1.91-1.99 GHz), according to one embodiment of the present invention. In the example of FIG. 3C, the BST capacitors 230, 232 were turned to approximately 0.066 pF and the BST capacitors 250, 252 were turned to 0.90 pF. The line 310 corresponds to the insertion loss characteristics of the transmitter side, and the line 312 corresponds to the insertion loss characteristics of the receiver side. Lines 310 and 312 are similar in shape to the lines 302 and 304 of FIG. 3A, respectively, and to the lines 306, 308 of FIG. 3B, respectively, except that the lines 310 and 312 are shifted to an even higher frequency due to the lowest values of the capacitances to which the BST capacitors 230, 232, 250, 252 are tuned.

Upon reading this disclosure, those of skill in the art will appreciate still additional alternative structural and functional designs for a tunable notch duplexer through the disclosed principles of the present invention. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A duplexer for a communication system, the duplexer coupled to a transmitter configured to transmit a transmit signal at a first frequency in a first frequency range and to a receiver configured to receive a receive signal at a second frequency in a second frequency range, the duplexer comprising:
a first tunable band reject filter coupled to the receiver and tunable to reject the first frequency in the first frequency range; and
a second tunable band reject filter coupled to the transmitter and tunable to reject the second frequency in the second frequency range.

2. The duplexer of claim 1, wherein the first tunable band reject filter comprises a first resonator including at least a first barium strontium titanate (BST) capacitor of which the capacitance is tunable by a first bias voltage applied to the first BST capacitor, and the second tunable band reject filter comprises a second resonator including at least a second barium strontium titanate (BST) capacitor of which the capacitance is tunable by a second bias voltage applied to the second BST capacitor.

3. The duplexer of claim 2, wherein the capacitance of the first BST capacitor is tunable between a first capacitance and a second capacitance higher than the first capacitance, lower and upper limits of the first frequency range corresponding to the second capacitance and the first capacitance, respectively.

4. The duplexer of claim 3, wherein the capacitance of the second BST capacitor is tunable between a third capacitance and a fourth capacitance higher than the third capacitance, lower and upper limits of the second frequency range corresponding to the fourth capacitance and the third capacitance, respectively.

5. The duplexer of claim 1, further comprising a first phase delay element coupled between the first tunable band reject filter and an antenna and a second phase delay element coupled between the second tunable band reject filter and the antenna.

6. The duplexer of claim 5, wherein the first phase delay element and second phase delay element comprise transmission lines.

7. The duplexer of claim 6, wherein the transmission lines comprise a co-axial resonator, a ceramic, or a printed circuit board.

8. A duplexer for a communication system, the duplexer coupled to a transmitter configured to transmit a transmit signal at a first frequency in a first frequency range and to a receiver configured to receive a receive signal at a second frequency in a second frequency range, the duplexer comprising:
first tunable band reject means coupled to the receiver and tunable to reject the first frequency in the first frequency range; and
second tunable band reject means coupled to the transmitter and tunable to reject the second frequency in the second frequency range.

9. The duplexer of claim 8, wherein the first tunable band reject means comprises a first resonator means including at least a tunable capacitance means, and the second tunable band reject means comprises a second resonator means including at least a second tunable capacitance means.

10. The duplexer of claim 9, wherein the first tunable capacitance means is tunable between a first capacitance and a second capacitance higher than the first capacitance, lower and upper limits of the first frequency range corresponding to the second capacitance and the first capacitance, respectively.

11. The duplexer of claim 10, wherein the second tunable capacitance means is tunable between a third capacitance and a fourth capacitance higher than the third capacitance, lower and upper limits of the second frequency range corresponding to the fourth capacitance and the third capacitance, respectively.
